(19) United States
(12) Patent Application Publication
(10) Pub. No.: US 2019/0271813 A1
(43) Pub. Date: Sep. 5, 2019

(54) FERRULE AND FERRULE WITH OPTICAL FIBER

(71) Applicant: KYOCERA Corporation, Kyoto-shi, Kyoto (JP)

(72) Inventors: Tomoyoshi AKASHI, Kitami-shi (JP); Satoru OKABE, Kitami-shi (JP)

(73) Assignee: KYOCERA Corporation, Kyoto-shi, Kyoto (JP)

(21) Appl. No.: 16/319,986

(22) PCT Filed: Jul. 21, 2017
(86) PCT No.: PCT/JP2017/026541

§ 371 Date: Jan. 23, 2019

(30) Foreign Application Priority Data
Jul. 28, 2016 (JP) 2016-148054

(51) Int. Cl. G02B 6/38

(52) U.S. Cl. CPC G02B 6/3829; G02B 6/3834

(57) ABSTRACT

A ferrule has a through-hole with first and second ends to receive an optical fiber fixed between the ends. The through-hole includes first to fifth portions defining the through-hole. The first portion has an inner diameter being smaller away from the first end. The second portion has an inner circumferential surface continuous with the first portion and along an optical axis of the optical fiber. The third portion has an inner circumferential surface continuous with the inner circumferential surface of the second portion and has an inner diameter being smaller away from the second portion. The fourth portion has an inner circumferential surface continuous with the inner circumferential surface of the third portion and along the optical axis. The fifth portion has an inner circumferential surface continuous with the inner circumferential surface of the fourth portion and has an inner diameter that is smaller away from the fourth portion.

### FIELD

The present invention relates to a ferrule and a ferrule with an optical fiber used in, for example, optical communication.

### BACKGROUND

An optical communication system includes optical fiber connectors for optically connecting optical fibers at positions where communication ports are optically coupled in a removable manner for allowing, for example, replacement, adjustment, or measurement of devices.

An optical fiber connector includes a ferrule with an optical fiber as a main component, and may include a housing, a spring, and an optical fiber strain relief boot. A ferrule has a through-hole in which a quartz optical fiber is placed and fixed. The tip of the ferrule is abutted against the tip of another ferrule to have the tips of their optical fibers in contact with each other and optically coupled together, enabling optical transmission between the two optical fibers.

Each ferrule has a through-hole, in which an optical fiber is placed and fixed. A typical optical fiber includes a bare fiber section including a bare optical fiber, and a fiber wire section including a portion of the bare optical fiber and a coating covering the portion of the bare optical fiber. The fiber wire section is fixed in the middle of the through-hole, and the bare fiber section is placed through a more distal portion of the through-hole (refer to Japanese Unexamined Patent Application Publication No. 2003-307649).

With the technique described in Japanese Unexamined Patent Application Publication No. 2003-307649, the fiber wire section is fixed in a portion of the through-hole parallel to the optical axis of the optical fiber. The bare fiber section placed in the more distal portion of the through-hole passes through a portion of the through-hole having a smaller inner diameter without leaving space inside the through-hole. However, with the technique described in Japanese Unexamined Patent Application Publication No. 2003-307649, the inner diameter of the through-hole decreases in its portion receiving the fiber wire section toward its portion receiving only the bare fiber section. The bare fiber section bent even slightly during insertion can hit the inner circumferential surface of the through-hole.

### BRIEF SUMMARY

A ferrule according to one aspect of the present invention comprises a through-hole in which an optical fiber is fixed and having a first end and a second end to receive the optical fiber between the first end and the second end. The through-hole includes a first portion, a second portion, a third portion, a fourth portion, and a fifth portion defining the through-hole. The first portion has an inner diameter that is smaller away from the first end. The second portion comprises an inner circumferential surface continuous with an inner circumferential surface of the first portion and along an optical axis of the optical fiber. The third portion comprises an inner circumferential surface continuous with the inner circumferential surface of the second portion and comprises an inner diameter that is smaller away from the second portion. The fourth portion comprises an inner circumferential surface continuous with the inner circumferential surface of the third portion and along the optical axis of the optical fiber. The fifth portion comprises an inner circumferential surface continuous with the inner circumferential surface of the fourth portion and an inner diameter that is smaller away from the fourth portion.

A ferrule with an optical fiber according to another aspect of the present invention includes an optical fiber and the ferrule according to the above aspect. The optical fiber includes a bare fiber section including a bare optical fiber, and a fiber wire section including a portion of the bare optical fiber and a coating covering the portion of the bare optical fiber. The optical fiber is fixed in the ferrule.

### BRIEF DESCRIPTION OF DRAWINGS

FIG. 1 is a cross-sectional view of a ferrule with an optical fiber according to an embodiment of the present invention.

FIG. 2 is a plan view of the optical fiber to be fixed to the ferrule according to the embodiment of the present invention.

FIG. 3 is a cross-sectional view of the ferrule yet to have the optical fiber according to the embodiment of the present invention.

FIG. 4 is an enlarged cross-sectional view of an area B of the ferrule shown in FIG. 3.

FIG. 5 is an enlarged cross-sectional view of an area A of the ferrule with the optical fiber according to the embodiment of the present invention shown in FIG. 1.

FIG. 6 is an enlarged cross-sectional view of a fourth portion in the ferrule with the optical fiber according to the embodiment of the present invention shown in FIG. 5.

### DETAILED DESCRIPTION

A ferrule with an optical fiber (optical fiber ferrule) according to an embodiment of the present invention includes an optical fiber 2 and a ferrule 3. The optical fiber 2 and the ferrule 3 in an optical fiber ferrule 1 according to an embodiment of the present invention will now be described in detail with reference to the drawings.

Structure of Optical Fiber

The optical fiber 2 includes a bare fiber section with an outer diameter of 125 μm as defined by, for example, the Japanese Industrial Standards (JIS) or the Telecommunications Industry Association/Electronic Industries Alliance (TIA/EIA) Standards, which is inserted through a first end 36 of the ferrule 3 into a through-hole 30, and is exposed through an opening at a second end 37 of the ferrule 3. The optical fiber 2 has one end flush with the second end 37 of the ferrule 3. The optical fiber 2 extends outside the ferrule through the first end 36. The optical fiber 2 is fixed to the ferrule 3 with an adhesive 4 filling the through-hole 30. The adhesive 4 may be an epoxy resin adhesive.

A portion of the optical fiber 2 outside the through-hole 30 is an optical fiber core 24 with a covering member. The covering member may be formed from, for example, a silicone resin, a nylon resin, an acrylic resin, or a polyester elastomer, and have an outer diameter of 0.9 mm.

As shown in FIG. 2, the optical fiber 2 includes a bare fiber section 21, which includes a bare optical fiber with no coating, and a fiber wire section 22, which includes a portion of the bare optical fiber adjacent to the first end 36 and a coating 23 covering the portion of the bare optical fiber. As described above, the bare fiber section 21 has an outer diameter of, for example, 125 μm. The fiber wire section 22 has an outer diameter of, for example, 0.25 mm. The optical fiber core 24, which is located outside the through-hole 30, is the fiber wire section 22 further covered with a covering member.

Structure of Ferrule

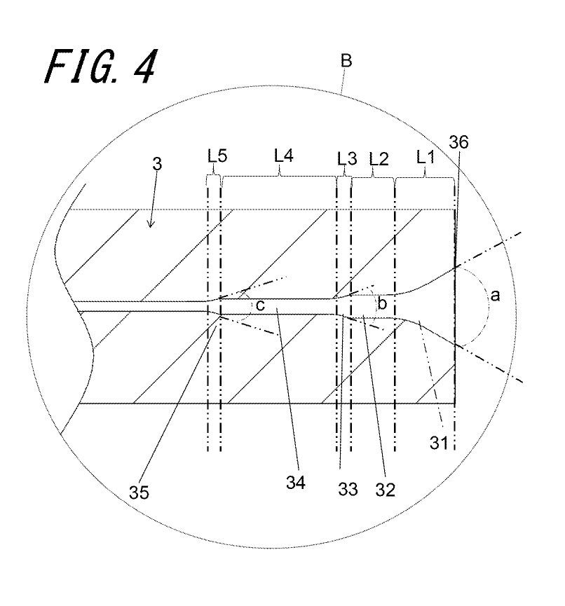

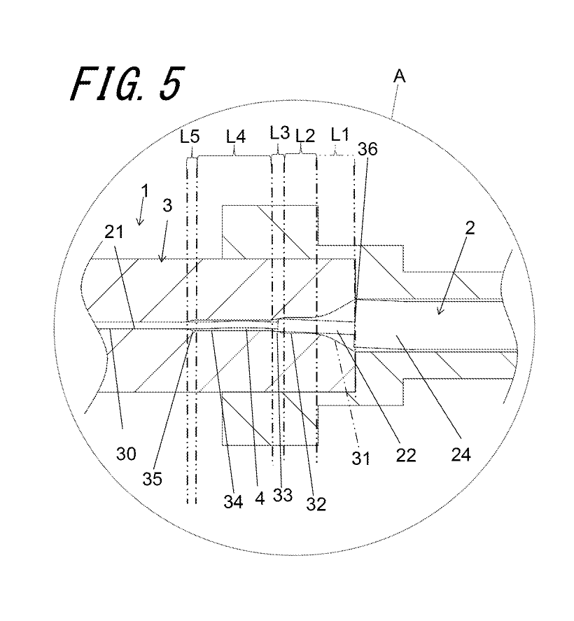

FIG. 3 is a cross-sectional view of the ferrule 3 according to the embodiment of the present invention. FIG. 4 is an enlarged cross-sectional view of an area B of the ferrule shown in FIG. 3. As in the examples shown in FIGS. 3 and 4, the ferrule 3 according to the present embodiment is substantially cylindrical, and has the through-hole 30 in which the optical fiber 2 inserted through the first end 36 is fixed. As shown in FIG. 4, lengths L1, L2, L3, L4, and L5 defined by two-dot chain lines sequentially from the first end 36 of the ferrule 3 are the lengths of a first portion 31, a second portion 32, a third portion 33, a fourth portion 34, and a fifth portion 35 in the through-hole direction. Angles a, b, and c are each defined by the facing inner circumferential surface portions of the first portion 31, the third portion 33, and the fifth portion 35, which will be described later.

The ferrule 3 has the first end 36 chamfered circumferentially, through which the optical fiber 2 is inserted. When the ferrule 3 is inserted from the second end 37 into an external device, this structure prevents the edge of the ferrule 3 from coming in contact with the external device, thus facilitating insertion of the ferrule 3.

The ferrule 3 may be formed from any of zirconium oxide (zirconia), aluminum oxide (alumina), mullite, silicon nitride, silicon carbide, or aluminum nitride, or ceramic containing any of these materials as a main component, or glass ceramic such as crystallized glass. In some embodiments, zirconia may be used as a main component to provide improved environmental resistance and toughness of the ferrule 3.

The dimensions of the ferrule 3 will now be described. The ferrule 3 is designed to receive the optical fiber 2, which includes the bare fiber section 21 with an outer diameter of 125 μm defined by the JIS or the TIA/EIA Standards. The ferrule 3 may have an outer diameter of 1 to 3 mm and a length of 6 to 23 mm.

The ferrule 3 has the through-hole 30 extending through its cylindrical body along the central axis and open at the first end 36 and the second end 37. This through-hole 30 receives and holds the optical fiber 2.

As shown in FIG. 4, the through-hole 30 includes the first portion 31, the second portion 32, the third portion 33, the fourth portion 34, and the fifth portion 35 between the first end 36 and the second end 37. The inner circumferential surfaces of the first portion 31 and the second portion 32 are continuous with each other. The inner circumferential surfaces of the second portion 32 and the third portion 33 are continuous with each other. The inner circumferential surfaces of the third portion 33 and the fourth portion 34 are continuous with each other. The inner circumferential surfaces of the fourth portion 34 and the fifth portion 35 are continuous with each other.

The first portion 31 receives the optical fiber 2 first when the optical fiber 2 is inserted into the ferrule 3. The first portion 31 opens at the first end 36 of the ferrule 3. The first portion 31 roughly positions the inserted optical fiber 2. The first portion 31 further receives an adhesive filling for fixing the inserted optical fiber 2 to the ferrule 3. The first portion 31 has an inner circumferential surface sloping with respect to the direction of the through-hole 30 in a cross section parallel to the direction of the through-hole 30. More specifically, the first portion 31 has an inner circumferential surface with an inner diameter that is smaller away from the first end 36 of the ferrule 3, or smaller toward the second end 37. In this structure, the first portion 31, which serves as a guide, receives the optical fiber 2 and thus facilitates insertion of the optical fiber 2 into the second portion 32.

The first portion 31 in the present embodiment may have an inner circumferential surface defined by straight lines as viewed in cross section. An angle a (hereafter, a first angle a) formed by extending the two straight lines may be 60° to 120° inclusive. The first angle a of 60° or greater provides a sufficient space between the surface of the first portion 31 and the optical fiber 2. This space is filled with an adhesive in a stable manner after the optical fiber 2 is inserted, enabling the optical fiber 2 to be joined more firmly to the ferrule 3. The first angle a of 120° or less allows the first portion 31 to serve as a guide in a stable manner. This facilitates movement of the tip of the optical fiber 2 along the first portion 31, and stable insertion of the optical fiber 2 into the second portion 32.

In some embodiments, the first portion 31 may have an inner circumferential surface curving with respect to the direction of the through-hole 30 as viewed in cross section. The first portion 31 with the inner circumferential surface curving with respect to the through-hole direction prevents the optical fiber 2 from breaking when hitting the inner circumferential surface of the first portion 31. The surface may curve more at positions inward in the through-hole 30. The surface convexly curving inward in the through-hole 30 easily guides the optical fiber 2 through the through-hole 30.

The first portion 31 may have an inner diameter of 0.6 to 1.1 mm at the first end 36, which is an opening end of the ferrule 3, an inner diameter of 0.25 to 0.3 mm at the other end nearer the second end 37, and a length L1 of 0.8 to 1.2 mm in the through-hole direction.

The second portion 32 is located between the first portion 31 and the third portion 33. The second portion 32 has an inner circumferential surface continuous with the inner circumferential surface of the first portion 31. The inner circumferential surface of the second portion 32 extends along the optical axis. In other words, the inner circumferential surface portions facing each other are substantially parallel. The inner circumferential surface portions facing each other being substantially parallel herein may include negligible variations resulting from errors in manufacturing the ferrule. The inner circumferential surface of the second portion 32 has a calculated average roughness Ra of, for example, 0.05 μm or less. The second portion 32 with the inner circumferential surface having the calculated average roughness Ra of 0.05 μm or less may lower the likelihood that the optical fiber 2 is damaged when inserted.

To facilitate insertion of the optical fiber 2 into the second portion 32, the first portion 31 has the inner diameter at the end nearer the second end 37 equal to the inner diameter of the second portion 32. To facilitate insertion of the optical fiber 2 into the third portion 33, the third portion 33 also has the inner diameter at the end nearer the first end equal to the inner diameter of the second portion 32. The inner diameters being equal herein may include negligible variations resulting from errors in manufacturing the ferrule 3.

The second portion 32 adjusts the insertion direction of the optical fiber 2, which is roughly positioned in the first portion 31, with respect to the direction of the through-hole 30. More specifically, although the optical fiber 2 is bent when inserted into the first portion 31, the second portion 32 with the inner diameter along the optical axis can straighten the bent optical fiber 2. This prevents the tip of the optical fiber 2 from receiving a force in a direction deviating from the direction of the through-hole 30 when the optical fiber 2 is inserted into the third portion 33.

The second portion 32 has a length L2 of, for example, 0.3 to 0.8 mm in the through-hole direction. The second portion 32 having the above length, in the same manner as the first portion 31, allows the insertion direction of the optical fiber 2 to be adjusted before the third portion 33, which has a smaller inner diameter than the inner diameters of the first portion 31 and the second portion 32, when the optical fiber 2 is moved within the second portion 32. This prevents the tip of the optical fiber 2 from receiving a force in an unintended direction when the optical fiber 2 is inserted into the third portion 33.

The second portion 32 has an inner diameter of 0.25 to 0.3 mm, which is the same as the inner diameter of the first portion 31 at its end nearer the second end. The second portion 32 may have the length L2 of 0.3 to 0.8 mm in the through-hole direction as described above. In this structure, the second portion 32 has an aspect ratio of 1.0 to 3.2.

The third portion 33 has an inner circumferential surface continuous with the inner circumferential surface of the second portion 32. The third portion 33 precisely positions the optical fiber 2, for which the insertion direction has been adjusted by the second portion 32. The third portion 33 has an inner circumferential surface sloping with respect to the direction of the through-hole 30 in a cross section parallel to the direction of the through-hole 30. More specifically, the third portion 33 has an inner circumferential surface continuous with the inner circumferential surface of the second portion 32 at its end nearer the second end 37, and has an inner diameter that is smaller away from the first end 36. In other words, the third portion 33 has an inner circumferential surface with an inner diameter that decreases toward the second end 37.

The third portion 33 is shorter than the first portion 31 and the second portion 32. Before passing through the third portion 33, the optical fiber 2 is roughly positioned in the first portion 31, and its insertion direction is adjusted in the second portion 32. Thus, although the third portion 33 is short, the optical fiber 2 can be properly inserted into the fourth portion 34.

The third portion 33 in the present embodiment has an inner circumferential surface defined by straight lines as viewed in cross section. An angle b (hereafter, a second angle b) formed by extending the two straight lines may be 0.1° to 90° inclusive. The second angle b of 0.1° or greater allows the third portion 33 to serve as a guide in a stable manner. Also, the second angle b of 90° or less causes no edge to form between the third portion 33 and the fourth portion 34, allowing stable insertion of the optical fiber 2 into the fourth portion 34. The second angle b is smaller than the first angle a. Thus, the third portion 33 can position the optical fiber 2 more reliably than the first portion 31.

In some embodiments, the third portion 33 may have an inner circumferential surface curving with respect to the direction of the through-hole 30 as viewed in cross section, in the same manner as the first portion 31. The third portion 33 with the inner circumferential surface curving with respect to the through-hole direction prevents the optical fiber 2 from breaking when hitting the inner circumferential surface of the third portion 33. The surface may convexly curve inward in the through-hole 30. The surface convexly curving inward in the through-hole 30 easily guides the optical fiber 2 through the through-hole 30.

The third portion 33 may have an inner diameter of 0.25 to 0.3 mm at one end nearer the first end 36, which is the same as the inner diameter of the second portion 32, an inner diameter of 0.15 to 0.23 mm at the other end nearer the second end 37, and a length L3 of 0.15 to 0.25 mm.

In the third portion 33, the fiber wire section 22 of the optical fiber 2 is fixed. The fiber wire section 22 fixed in the third portion 33 lowers the likelihood of a positional shift of the bare fiber section 21 with respect to the fourth portion 34. This structure also lowers the likelihood that the optical fiber 2 is damaged when inserted into the fourth portion 34.

The fourth portion 34 has an inner circumferential surface continuous with the inner circumferential surface of the third portion 33. The fourth portion 34 holds the bare fiber section 21 of the inserted optical fiber 2. The fourth portion 34 has the inner circumferential surface continuous with the inner circumferential surface of the third portion 33 at its end nearer the second end 37, and opens toward the second end 37 of the ferrule 3. The inner circumferential surface of the fourth portion 34 extends along the optical axis. In other words, the inner circumferential surface portions facing each other are substantially parallel. The inner circumferential surface portions facing each other being substantially parallel herein may include negligible variations resulting from errors in manufacturing the ferrule 3. The inner circumferential surface of the fourth portion 34 has a calculated average roughness Ra of, for example, 0.05 μm or less. The inner circumferential surface of the fourth portion 34 with the calculated average roughness Ra of 0.05 μm or less may lower the likelihood that the optical fiber 2 is damaged when inserted. The fourth portion 34 may have an inner diameter of 0.15 to 0.23 mm, which is the same as the inner diameter of the third portion 33 at its end nearer the second end 37. The fourth portion 34 has an aspect ratio of 4.35 to 16.67.

In the fourth portion 34, only the bare fiber section 21 of the optical fiber 2 is inserted and fixed. The fourth portion 34 has a larger inner diameter than the bare fiber section 21, and is long in the through-hole direction. Thus, the bare fiber section 21 is bent in the fourth portion 34. In the fourth portion 34, the bare fiber section 21 has a curvature R of 20 mm or greater. The optical fiber 2 bent in the fourth portion 34 is prevented from being broken. Thus, the optical fiber remains in a good condition. In this case, the optical axis has almost no misalignment.

The fourth portion 34 has a length of, for example, 1.4 to 1.6 mm in the through-hole direction. The fourth portion 34 is longer in the through-hole direction than the first portion 31, the second portion 32, the third portion 33, and the fifth portion 35 (described later). In other words, the length L4 is greater than the lengths L1, L2, L3, and L5. The optical fiber 2 is moved through the fourth portion 34 to allow the insertion direction of the optical fiber 2 to be adjusted before the fifth portion 35, which has a further reduced inner diameter. This prevents the tip of the optical fiber 2 from receiving a force in an unintended direction when the optical fiber 2 is inserted into the fifth portion 35.

The fifth portion 35 has an inner circumferential surface continuous with the inner circumferential surface of the fourth portion 34. The fifth portion 35 precisely positions the optical fiber 2, for which the insertion direction has been adjusted by the fourth portion 34. The fifth portion 35 has an inner circumferential surface sloping with respect to the direction of the through-hole 30 in a cross section parallel to the direction of the through-hole 30. More specifically, the inner circumferential surface of the fifth portion 35 is continuous with the inner circumferential surface of the fourth portion 34 at its end nearer the second end 37, and has an inner diameter that is smaller away from the first end 36. In other words, the fifth portion 35 has an inner circumferential surface with an inner diameter that decreases toward the second end 37.

The fifth portion 35 is shorter than the fourth portion 34. The bare fiber section 21 of the optical fiber 2 is roughly positioned in the third portion 33, and has its insertion direction adjusted in the fourth portion 34 before passing through the fifth portion 35. Thus, although the fifth portion 35 is short, the bare fiber section 21 of the optical fiber 2 can be properly inserted toward the second end 37.

The fifth portion 35 in the present embodiment has an inner circumferential surface defined by straight lines as viewed in cross section. An angle c (hereafter, a third angle c) formed by extending the two straight lines may be 0.1° to 90° inclusive. The third angle c of 0.1° or greater allows the fifth portion 35 to serve as a guide in a stable manner. Also, the third angle c of 90° or less causes no edge to form between the fifth portion 35 and a portion extending further toward the second end 37, thus allowing stable insertion of the optical fiber 2 toward the second end 37. Thus, the fifth portion 35 can position the optical fiber 2 in a more reliable manner.

In some embodiments, the fifth portion 35 may have an inner circumferential surface curving with respect to the direction of the through-hole 30 as viewed in cross section, in the same manner as the first portion 31 and the third portion 33. The fifth portion 35 with the inner circumferential surface curving with respect to the through-hole direction prevents the optical fiber 2 from breaking when hitting the inner circumferential surface of the fifth portion 35. The surface may convexly curve inward in the through-hole 30. The surface convexly curving inward in the through-hole 30 easily guides the optical fiber 2 through the through-hole 30.

The fifth portion 35 may have an inner diameter of 0.15 to 0.23 mm at one end nearer the first end 36, which is the same as the inner diameter of the fourth portion 34, an inner diameter of 0.125 to 0.126 mm at the other end nearer the second end 37, and a length L5 of 0.18 to 0.22 mm.

In the ferrule 3 according to the present embodiment, the optical fiber 2 is roughly positioned in the first portion 31, and its insertion direction is adjusted in the second portion 32, and then passes through the third portion 33, before the fiber wire section 22 of the optical fiber 2 is fixed. Thus, when inserted into the third portion 33, the optical fiber 2 is prevented from receiving a force in its tip in a direction deviating from the direction of the through-hole 30. This structure lowers the likelihood that the optical fiber 2 is damaged when inserted into the ferrule 3.

The fiber wire section 22 is fixed in the third portion 33 of the ferrule 3. The bare fiber section 21 is fixed across the fourth portion 34 and the fifth portion 35 to the second end 37 of the ferrule 3. The bare fiber section 21 is bent in the fourth portion 34 to lower the likelihood that the optical fiber 2 is damaged when inserted into the ferrule 3.

### Method for Manufacturing Ferrule

An example method for manufacturing the ferrule 3 will now be described. In the example below, a ceramic mainly containing zirconia (zirconium ceramic) is used as a material for the ferrule 3.

A compound for forming a compact, which is a base of the ferrule 3, is first prepared. The compound is specifically prepared by sufficiently grinding a mixture of zirconium oxide powder and yttrium oxide powder with, for example, a ball mill and then mixing the resultant product with a binder. The mixture may contain 85 to 99 mass % of zirconium oxide powder and 1 to 15 mass % of yttrium oxide powder, or 90 to 98 mass % of zirconium oxide powder and 2 to 10 mass % of yttrium oxide powder. Zirconium oxide power with a zirconium oxide purity of 95% or more, specifically 98% or more, may be used.

A compact with the through-hole 30 is then obtained from the prepared compound. More specifically, the compound is placed into the cavity of a molding die for forming the through-hole 30, and then is pressed under a predetermined pressure to obtain the compact. The method for obtaining the compact is not limited to press molding described above, and may be another method, such as injection molding, casting, cold isostatic pressing, or extrusion molding.

The resultant compact is then fired to obtain a sintered compact. More specifically, the resultant compact is put into a dewaxing furnace and dewaxed at 500 to 600° C. for 2 to 10 hours. The dewaxed compact is then fired at 1300 to 1500° C. in an oxygen atmosphere for 0.5 to 3 hours to obtain a sintered compact.

The inner circumferential surface of the through-hole 30 of the resultant sintered compact is then ground to form the first portion 31, the second portion 32, the third portion 33, the fourth portion 34, and the fifth portion 35. More specifically, the ferrule 3 is rotated about the rotational axis of the through-hole 30, with a grinding wheel pressed at the through-hole 30 to form the first portion 31, the second portion 32, the third portion 33, the fourth portion 34, and the fifth portion 35. A grinding fluid may be used to allow grinding without increasing the roughness of the inner surface. The ferrule 3 is manufactured as described above.

Structure of Ferrule with Optical Fiber

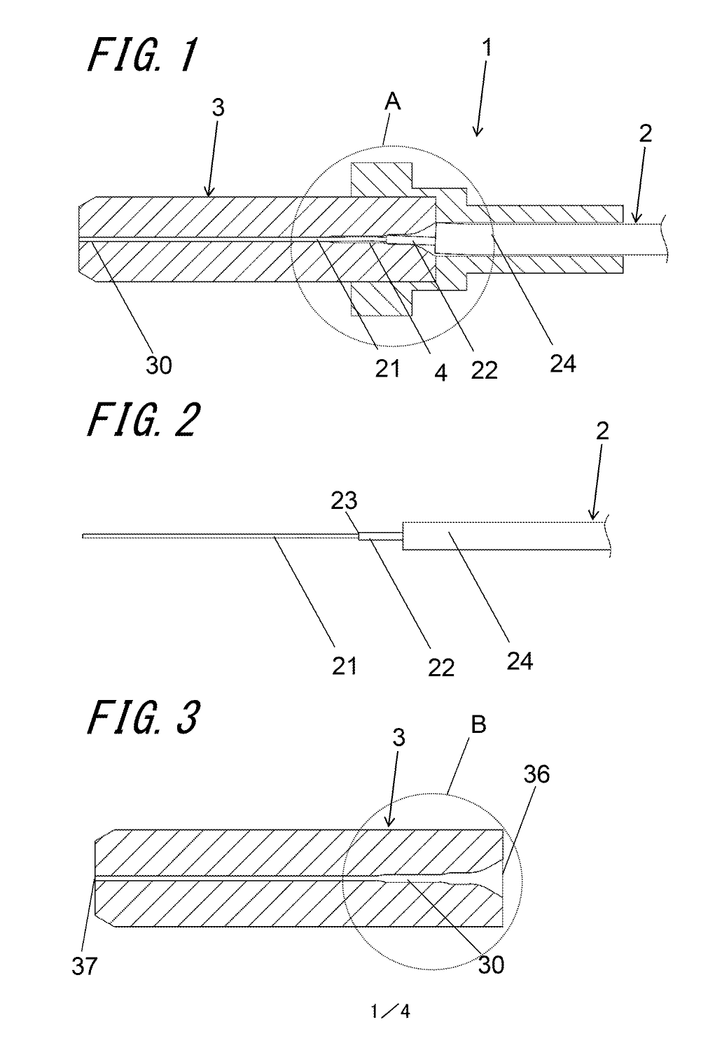

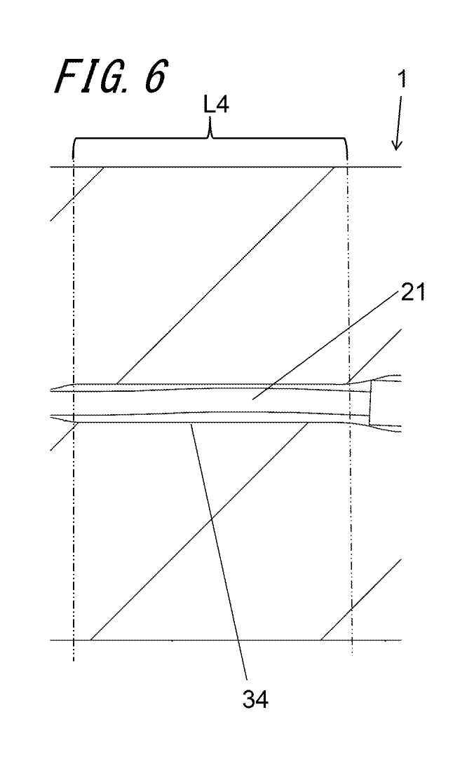

FIG. 5 is an enlarged cross-sectional view of an area A of the ferrule with the optical fiber according to an embodiment of the present invention shown in FIG. 1. FIG. 6 is an enlarged view of the fourth portion in the ferrule with the optical fiber according to the embodiment of the present invention shown in FIG. 5. FIG. 5 shows the positional relationship between the optical fiber 2 and the ferrule 3 described above. FIG. 5 shows the lengths L1, L2, L3, L4, and L5 of the first portion 31, the second portion 32, the third portion 33, the fourth portion 34, and the fifth portion 35 of the ferrule 3 in the through-hole direction defined by the two-dot chain lines sequentially from the first end 36 in the same manner as in FIG. 4.

The fiber wire section 22 of the optical fiber 2 is inserted through the first portion 31 and fixed in the third portion 33. The fiber wire section 22 may be in contact with the inner circumferential surface of the first portion 31. The fiber wire section 22 in contact with the inner circumferential surface of the first portion 31 easily positions the inserted optical fiber 2.

The fiber wire section 22 may be in contact with the inner circumferential surface of the second portion 32. The fiber wire section 22 in contact with the inner circumferential surface of the second portion 32 easily positions the inserted optical fiber 2 in the same manner as in the first portion 31.

As shown in FIG. 6, the bare fiber section 21 of the optical fiber 2 is bent in the fourth portion 34. The bare fiber section 21 bent in the fourth portion 34 may lower the likelihood that the bare fiber section 21 is damaged when inserted into the fourth portion 34 and the fifth portion 35.

In the optical fiber ferrule 1 with the structure described above, the optical fiber 2 is roughly positioned in the first portion 31, and its insertion direction is adjusted in the second portion 32, and then passes through the third portion 33, before the fiber wire section 22 of the optical fiber 2 is fixed. Thus, when inserted into the third portion 33, the optical fiber 2 is prevented from receiving a force in its tip in a direction deviating from the direction of the through-hole 30. Also, the optical fiber 2 may be bent in the fourth portion 34. This structure lowers the likelihood that the optical fiber 2 is damaged when inserted into the ferrule 3.

The present invention is not limited to the embodiment described above, and may be modified or changed variously without departing from the spirit and scope of the present invention.

### REFERENCE SIGNS LIST

1 optical fiber ferrule
2 optical fiber
3 ferrule
4 adhesive
21 bare fiber section
22 fiber wire section
23 coating
24 optical fiber core
30 through-hole
31 first portion
32 second portion
33 third portion
34 fourth portion
35 fifth portion
36 first end
37 second end

1. A ferrule, comprising:
a through-hole in which an optical fiber is fixed, the through-hole comprising a first end and a second end to receive the optical fiber between the first end and the second end, wherein the through-hole comprises
the first portion having an inner diameter that is smaller away from the first end,
the second portion comprising an inner circumferential surface which is continuous with an inner circumferential surface of the first portion and is along an optical axis of the optical fiber,
the third portion comprising an inner circumferential surface continuous with the inner circumferential surface of the second portion and having an inner diameter that is smaller away from the second portion,
the fourth portion comprising an inner circumferential surface which is continuous with the inner circumferential surface of the third portion and is along the optical axis of the optical fiber, and
the fifth portion comprising an inner circumferential surface continuous with the inner circumferential surface of the fourth portion and having an inner diameter that is smaller away from the fourth portion.

2. The ferrule according to claim 1, wherein
the inner circumferential surface of the third portion curves with respect to a direction of the through-hole.

3. The ferrule according to claim 1, wherein
the fourth portion is longer in the direction of the through-hole than the first portion, the second portion, the third portion, and the fifth portion.

4. The ferrule according to claim 1, wherein
the inner circumferential surface of the fifth portion curves with respect to the direction of the through-hole.

5. A ferrule with an optical fiber, comprising:
an optical fiber including a bare fiber section including a bare optical fiber, and a fiber wire section including a portion of the bare optical fiber and a coating covering the portion of the bare optical fiber; and
the ferrule according to claim 1 in which the optical fiber is fixed.

6. The ferrule with the optical fiber according to claim 5, wherein
the fiber wire section comprises an outer diameter smaller than an inner diameter of a part of the third portion adjacent to the second portion and larger than an inner diameter of a part of the third portion adjacent to the fourth portion, the fiber wire section is fixed in the third portion, and the bare fiber section is bent in the fourth portion.

7. The ferrule with the optical fiber according to claim 5, wherein
the fiber wire section is in contact with the inner circumferential surface of the first portion.

8. The ferrule with the optical fiber according to claim 5, wherein
the fiber wire section is in contact with the inner circumferential surface of the second portion.
